(19) United States
(12) Patent Application Publication
(10) Pub. No.: US 2011/0195203 A1
(43) Pub. Date: Aug. 11, 2011

(54) GAS BARRIER FILM MANUFACTURING METHOD

(75) Inventor: Tatsuya FUJINAMI, Kanagawa (JP)

(73) Assignee: FUJIFILM CORPORATION, Tokyo (JP)

(21) Appl. No.: 13/024,822

(22) Filed: Feb. 10, 2011

(30) Foreign Application Priority Data
Feb. 10, 2010 (JP) 2010-027629

(51) Int. Cl. H05H 1/42

(52) U.S. Cl. 427/577

(57) ABSTRACT

A gas barrier film of high flexibility exhibiting a good gas barrier property over a long period of time is manufactured by a method of manufacturing a gas barrier film by capacitively-coupled plasma CVD using silane gas, ammonia gas, and hydrogen gas and/or nitrogen gas as gaseous raw materials, in which a silicon nitride layer is deposited on a base film at a ratio P/Q of less than 10 [W/sccm], with Q being the silane gas flow rate and P being the plasma-generating electric power, a deposition pressure of 20 to 200 Pa, and at a base film temperature of not more than 70° C. under a bias potential of not more than −100 V applied to the base film.

### BACKGROUND OF THE INVENTION

The present invention relates to gas barrier film manufacturing methods utilizing capacitively-coupled plasma CVD.

A resin (plastic) film having a silicon nitride layer deposited on the surface thereof is known as a gas (water vapor) barrier film for a variety of devices, optical elements, and so forth required to be moisture proof.

In this regard, capacitively-coupled plasma CVD (CCP-CVD) is a known process for depositing a silicon nitride layer.

As is well-known, in a method of depositing a layer by CCP-CVD, a pair of electrodes are used between which gaseous raw materials are fed and a voltage is applied to generate plasma, and the plasma causes dissociation or ionization of the gaseous raw materials to make radicals or ions generated, so that a layer is deposited by plasma CVD on the surface of the object to be treated which is placed between the electrodes.

The method by CCP-CVD as above is advantageous in that only a system of simple configuration is required, that gaseous raw materials, as being fed through an electrode, are fed uniformly throughout the deposition area even if large-area electrodes are used (easy equalization of gas feeding), which facilitates treatment of large-area base films, and so forth.

As an example, JP 2005-342975 A discloses the transparent gas barrier film whose silicon nitride layer has an element ratio N/Si of 0.8 to 1.4 and a density of 2.1 to 3.0 g/cm³.

In Examples of the reference, gas barrier films were each manufactured by using a polyether sulfone film as a base film as well as silane gas, ammonia gas and hydrogen gas as gaseous raw materials, and forming a silicon nitride layer by a CCP-CVD process under such conditions that the base film temperature was 150° C., the silane gas flow rate was 2 to 20 sccm, 300 W of electric power was supplied, and the deposition pressure was 10 Pa.

### SUMMARY OF THE INVENTION

As described in JP 2005-342975 A, resin films are used as a base film of a gas barrier film.

While a silicon nitride layer is deposited at a base film temperature of 150° C. in JP 2005-342975 A using a polyether sulfone film as a base film, deposition of a silicon nitride layer at a base film temperature of 150° C. is hardly possible on inexpensive resin films of low resistance to heat, such as polyethylene terephthalate (PET) films.

In addition, a deposition pressure of 10 Pa requires a high-performance deposition apparatus, which extremely raise the apparatus costs especially if the productivity is to be improved, that is to say, the flow rate of a gaseous raw material is to be enhanced.

A silane gas flow rate of 2 to 20 sccm and 300 W of electric power supplied make a layer deposited densely, so that the layer is inadequately flexible and less resistant to flexing. The layer as such may be broken and reduced in gas barrier property if bent, for instance.

In a so-called roll-to-roll deposition method, a continuous base film in a rolled form is delivered from the roll and transported in its longitudinal direction, with a functional layer being deposited on the base film as being transported, and the base film with the functional layer deposited thereon is rolled up. A layer deposited in particular by such a method as above, in which a base film is rolled and transported with somewhat bending, may be broken and reduced in gas barrier property due to the bending upon transportation or rolling up of the base film if the layer is inadequately flexible and less resistant to flexing.

An object of the present invention is to solve the above problems with the prior art so as to provide a gas barrier film manufacturing method which makes it possible to use a resin film having a low resistance to heat, such as PET film, as a base film to manufacture a gas barrier film of high quality exhibiting an excellent gas barrier property and a high flexibility on an inexpensive apparatus with a high productivity.

In order to achieve the above object, according to the present invention, there is provided a method of manufacturing a gas barrier film, including: using silane gas, ammonia gas, and either one or both of nitrogen gas and hydrogen gas as gaseous raw materials; and depositing a silicon nitride layer on a surface of a base film by capacitively-coupled plasma CVD at a ratio P/Q [W/sccm] of less than 10 W/sccm, with Q [sccm] being a flow rate of the silane gas and P [W] being electric power supplied for plasma generation, a deposition pressure of 20 to 200 Pa, and at a base film temperature of not more than 70° C. while applying a bias potential of not more than −100 V to the base film.

In the method of manufacturing a gas barrier film according to the present invention, it is preferable that the bias potential applied to the base film has a frequency of not less than 100 kHz. Further, it is preferable that the bias potential applied to the base film has a frequency of not less than 400 kHz.

Further, it is preferable that the base film is a continuous base film rolled up into a base film roll, which is delivered from the base film roll, transported in its longitudinal direction, and subjected to deposition of said silicon nitride layer during transportation, and the base film with said silicon nitride layer deposited thereon is rolled up. Further, it is preferable that the base film is transported along a path having a section in which said base film is bent at a radius of curvature of not more than 50 mm. Further, it is preferable that the base film is wound onto a cylindrical drum in a specified area of a peripheral surface thereof during transportation, and the drum is used as an electrode for deposition. Further, it is preferable that a temperature adjusting means is used to adjust said drum in temperature.

Further, it is preferable that the flow rate Q [sccm] of the silane gas and said electric power P [W] supplied for plasma generation satisfy an expression 1≦P/Q<10 [W/sccm]. Further, it is preferable that a material for said base film is a resin having a glass transition temperature of not more than 70° C. Further, it is preferable that the bias potential applied to the base film is not less than −700 V and at the same time not more than −100 V. Furthermore, it is preferable that the deposition pressure is 40 to 100 Pa.

According to the present invention with the configuration as described above, a resin film having a low resistance to heat, such as PET film, can be used as a base film to manufacture a gas barrier film of high quality exhibiting an excellent gas barrier property and a high flexibility, with the reduction in gas barrier property due to particles getting into the gas barrier layer of the film being suppressed significantly, on an inexpensive manufacturing apparatus, and with a high productivity as a result of employing a roll-to-roll method or the like.

### BRIEF DESCRIPTION OF THE DRAWING

FIG. 1 is a schematic diagram showing an example of the plasma CVD apparatus for implementing the gas barrier film manufacturing method of the present invention.

### DETAILED DESCRIPTION OF THE INVENTION

The following description is made in order to illustrate the gas barrier film manufacturing method according to the present invention in reference to the attached drawing.

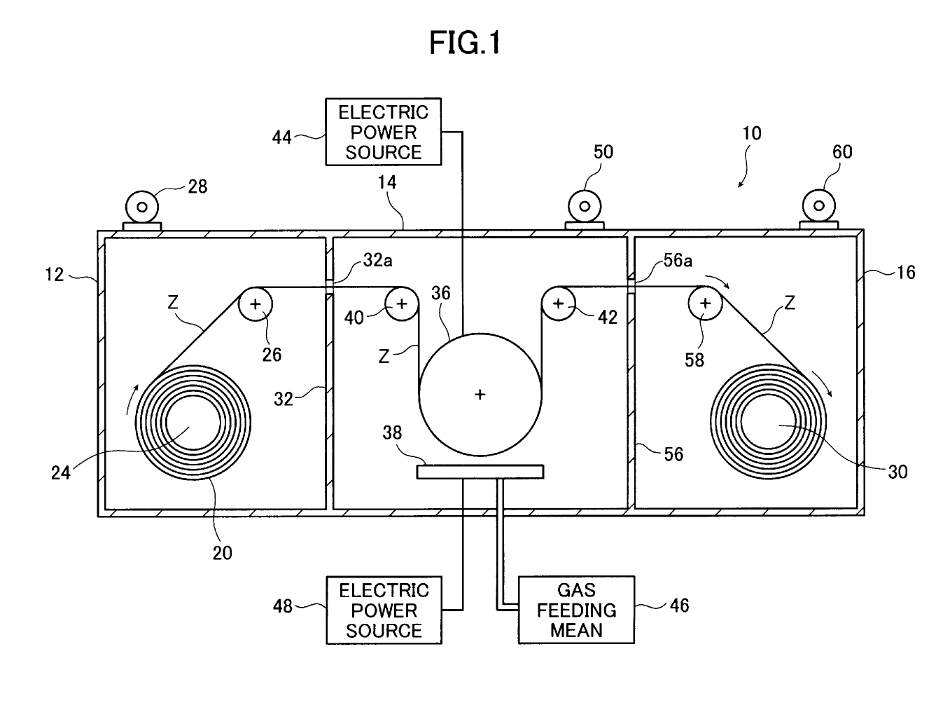

FIG. 1 schematically shows an example of the plasma CVD apparatus for implementing the inventive method of manufacturing a gas barrier film.

A plasma CVD apparatus 10 (hereafter referred to as “CVD apparatus 10”) shown in FIG. 1 is an apparatus for depositing (forming) a silicon nitride layer as a gas barrier layer on the surface of a base film Z (object to be treated/base) by capacitively-coupled plasma CVD (CCP-CVD) to manufacture a gas barrier film.

The CVD apparatus 10 shown as an example is adapted to transport a continuous base film Z (base film web) in its longitudinal direction, and deposit (make/form) various functional layers by plasma CVD on the surface of the base film Z as being transported, so as to manufacture a functional film.

In other words, the CVD apparatus 10 is the apparatus for roll-to-roll deposition on which the continuous base film Z as rolled up into a base film roll 20 is delivered from the roll 20, transported in its longitudinal direction, and subjected to the deposition of a functional layer during transportation, and the base film Z with the functional layer deposited thereon (namely, the functional film thus obtained) is rolled up.

As described above, the CVD apparatus 10 of FIG. 1 adapted to deposit a layer on the surface of the base film Z by CCP-CVD (a CCP-CVD process) is the apparatus for roll-to-roll deposition on which the continuous base film Z as rolled up into the base film roll 20 is delivered from the roll 20, transported in its longitudinal direction, subjected to the deposition of a functional layer during transportation, then rolled up again. The CVD apparatus 10 as such has a feeding chamber 12, a deposition chamber 14, and a roll up chamber 16.

The CVD apparatus 10 may have, apart from the shown members, a variety of members of a conventional apparatus for roll-to-roll deposition by plasma CVD, including such members (means) as for transporting the base film Z along a specified path, for instance, various sensors, transporting roller pairs, or guide members for positioning the base film Z in its lateral direction. In addition, the chamber for deposition by plasma CVD may be more than one in number, and one or more chambers for deposition by CVD other than plasma CVD, flash evaporation, sputtering or the like, or for surface treatment such as plasma treatment, may be coupled to the plasma CVD chamber or chambers.

The present invention uses the conventional CVD apparatus 10 as described above to deposit a silicon nitride layer on the surface of the base film Z basically by a common CCP-CVD process using silane gas, ammonia gas, and hydrogen gas and/or nitrogen gas as gaseous raw materials with the exception that the relationship between the silane gas flow rate and the major electric power applied for plasma generation, as well as the deposition pressure, the temperature of the base film Z, and the bias potential to be applied to the base film Z are defined according to the present invention as detailed later.

The base film Z (object to be treated) is not particularly limited, so that any object (article) is available as long as a silicon nitride layer is deposited on it by CCP-CVD using silane gas, ammonia gas, and hydrogen gas and/or nitrogen gas as gaseous raw materials.

For example, various objects in film form having a low resistance to heat, such as a resin film (plastic film) of low resistance to heat having a glass transition temperature of not more than 70° C., a polyethylene terephthalate (PET) film, for instance, are considered to be preferable base films because of their allowing the effects of the present invention to be exerted more suitably.

In the present invention, the base film Z may be any of various films as above used as the body (base) which has organic or inorganic layers for imparting various functions to a manufactured film, such as a protective layer, an adhesive layer, a light-reflecting layer, a shading layer, a flattening layer, a buffer layer, and a stress-relaxing layer, formed on its surfaces (at least the surface for deposition).

The feeding chamber 12 is provided with a rotating shaft 24, a guide roller 26, and a means of vacuum evacuation 28.

The base film roll 20 as the continuous base film Z in a rolled form is to be loaded on the rotating shaft 24 in the feeding chamber 12.

With the base film roll 20 being loaded on the rotating shaft 24, the base film Z is caused to pass through (is transported along) the transportation path so defined as to extend from the feeding chamber 12 to a roll up shaft 30 in the roll up chamber 16 via the deposition chamber 14.

On the manufacturing apparatus 10, the delivery of the base film Z from the base film roll 20 and the roll up of the base film Z on the roll up shaft 30 in the roll up chamber 16 are synchronized with each other, and the continuous base film Z transported in its longitudinal direction along the defined path is subjected to an uninterrupted deposition of a functional layer by plasma CVD in the deposition chamber 14.

In the feeding chamber 12, the rotating shaft 24 is rotated by a driving source (not shown) clockwise in the plane of drawing so as to deliver the base film Z from the base film roll 20, then the base film Z is guided by the guide roller 26 along the defined path through a slit 32a provided in a partition 32 to the deposition chamber 14.

In the manufacturing apparatus 10 shown as a preferred embodiment, the feeding chamber 12 and the roll up chamber 16 are provided with the means of vacuum evacuation 28 and a means of vacuum evacuation 60, respectively. During the deposition of a layer, the means of vacuum evacuation 28 and 60 allow the same degree of vacuum (pressure) in the chambers 12 and 16 as in the deposition chamber 14 as will be described later, so as to prevent the pressures in the chambers adjacent to the deposition chamber 14 from affecting the degree of vacuum in the chamber 14 (that is to say, affecting the deposition of a functional layer).

The means of vacuum evacuation 28 is not particularly limited, so that vacuum pumps such as a turbomolecular pump, a mechanical booster pump, a dry pump and a rotary pump, or even a variety of known means of (vacuum) evacuation used in vacuum deposition apparatus and utilizing auxiliary means such as cryocoil, means for adjusting the degree of vacuum to be achieved or the amount of evacuation, and so forth, are available. The same applies to the means of vacuum evacuation 50 and 60 as described later.

The present invention is not limited to the configuration in which every chamber is provided with a means of vacuum evacuation, that is to say, a means of vacuum evacuation may not be attached to the feeding chamber 12 or the roll up chamber 16 in which no treatment requiring vacuum evacuation is performed. In that case, the opening in a partition that the base film Z passes through, such as the slit 32a, may be made as small as possible, or a sub-chamber may be provided between chambers so as to reduce the pressure in the sub-chamber, in order that the pressures in the chambers 12 and 16 less affect the degree of vacuum in the deposition chamber 14.

It is preferable that, also in the manufacturing apparatus 10 as shown, of which every chamber is provided with a means of vacuum evacuation, the openings which the base film Z passes through, such as the slit 32a, are made as small as possible.

As described before, the base film Z is guided by the guide roller 26 to the deposition chamber 14.

In the deposition chamber 14, a functional layer is deposited (formed) on the surface of the base film Z by capacitively-coupled plasma CVD (CCP-CVD).

In the shown example, the deposition chamber 14 is provided with a drum 36, a showerhead electrode 38, guide rollers 40 and 42, a bias power source 44, a gas feeding means 46, a radio-frequency power source 48, and a means of vacuum evacuation 50.

The drum 36 in the deposition chamber 14 is a cylindrical member rotating about its central axis counterclockwise in the plane of drawing. The base film Z guided by the guide roller 40 along the defined path is wound onto the drum 36 in a specified area of the peripheral surface of the drum, and transported in its longitudinal direction while held in a specified position by the drum 36 so that it may be opposite to the showerhead electrode 38 as described later.

In the CVD apparatus 10 as shown, a temperature adjusting means (not shown) is built in the drum 36 in order to keep the temperature of the base film Z at 70° C. or lower during the deposition of a silicon nitride layer.

The temperature adjusting means is not particularly limited, so that a temperature adjusting means causing a liquid for temperature adjustment to flow inside the drum 36 (in a channel defined inside the drum 36), a cooling means using a piezoelectric element, or any other known temperature adjusting means is available as long as it is capable of keeping the temperature of the base film Z at 70° C. or lower during deposition.

In the shown example, the drum 36 also serves as one electrode constituting an electrode pair for deposition by CCP-CVD (counter electrode to an electrode supplied with the major electric power for plasma generation), and is connected with the bias power source 44. In other words, the drum 36 also serves as a counter electrode to the showerhead electrode 38 supplied with the major electric power for plasma generation.

The bias power source 44 is a radio-frequency power source (RF power source) applying a voltage of not more than −100 V to the drum 36 (supplying the drum 36 with electric power allowing the potential of the drum 36 to be −100 V in accordance with the deposition pressure and so forth). In the shown example, the bias power source 44 applies a bias potential of not more than −100 V to the base film Z by applying a voltage of not more than −100 V to the drum 36. Preferably, the bias power source 44 applies a radio-frequency potential at a frequency of not less than 100 kHz to the base film Z, which will be detailed later.

In the present invention, the electric power source to be used for applying a bias potential to the base film Z is not limited to the radio-frequency power source as shown, so that various electric power sources used in CCP-CVD processes to apply a bias potential to a base film, such as a DC pulse power source, are available. In other words, the bias potential to be applied to the base film Z may be a radio-frequency potential or a pulse potential as long as it is −100 V or lower. If a DC pulse power source is to be used, it is preferable to apply a pulse potential at a frequency of not less than 100 kHz to the base film Z as a bias potential.

If a radio-frequency power source is to be used as the bias power source 44 as is the case with the shown example, it is also possible as required to apply a bias potential to the drum 36 through a known impedance matcher matching power impedance.

In the shown example, the showerhead electrode 38 is in the shape of a hollow, rectangular parallelepiped, for instance, and is positioned so that a largest face thereof may be opposite to the drum 36 retaining the base film Z and serving as an electrode also.

The showerhead electrode 38 is an electrode supplied with the major electric power (main electric power) for plasma generation, and constitutes along with the drum 36 an electrode pair for CCP-CVD. The showerhead electrode 38 is connected with the radio-frequency power source 48 as described later.

The showerhead electrode 38 has multiple through-holes formed in its face opposite to the drum 36 over the entire area thereof. In addition, the showerhead electrode 38 is coupled to the gas feeding means 46, which feeds gaseous raw material inside the showerhead electrode 38.

In other words, the showerhead electrode 38 serves not only as an electrode but a means for introducing gaseous raw material, and the gaseous raw material as fed from the gas feeding means 46 into the showerhead electrode 38 are then fed between the drum 36 also serving as an electrode and the showerhead electrode 38 through the through-holes formed in the face opposite to the drum 36.

The gas feeding means 46 is a known gas feeding means adapted for plasma CVD apparatus, sputtering apparatus, and so forth.

In the present invention, the gas feeding means 46 feeds either one or both of hydrogen gas and nitrogen gas, as well as silane gas and ammonia gas, to the showerhead electrode 38. The gas feeding means 46 may feed, apart from the above gases, a subsidiary gas such as an inert gas, argon gas for instance, to the showerhead electrode 38 as required.

The present invention is not limited to the configuration in which a showerhead electrode is employed. Various gas introducing means used for conventional plasma CVD apparatus are available, including the method in which the electrode to be supplied with the major electric power for plasma generation is caused to serve solely as an electrode, and gaseous raw materials are fed through a nozzle, or a showerhead-type nozzle, for gas feeding provided between the electrode and the drum 36.

As described before, the showerhead electrode 38 is connected with the radio-frequency power source 48.

The radio-frequency power source 48 is an electric power source for supplying the main electric power for plasma generation in CCP-CVD to the showerhead electrode 38, and a variety of known radio-frequency (RF) power sources used in plasma CVD apparatus are available as such an electric power source.

If necessary, the radio-frequency power source 48 may also supply a plasma-exciting electric power to the showerhead electrode 38 through a known impedance matcher matching power impedance.

The means of vacuum evacuation 50, as being adapted to evacuate the deposition chamber 14 so as to maintain the deposition pressure in the chamber 14 as specified for the deposition of a functional layer by plasma CVD, is any of the above known means of vacuum evacuation used for vacuum deposition apparatus.

According to the present invention, silane gas (SiH₄), ammonia gas (NH₃), and either one or both of hydrogen gas (H₂) and nitrogen gas (N₂) are used as gaseous raw materials to deposit a silicon nitride layer on the surface of the base film Z by CCP-CVD at a ratio P/Q [W/sccm] of less than 10 W/sccm, with Q [sccm] being the silane gas flow rate and P [W] being the major electric power supplied for plasma generation, a deposition pressure of 20 to 200 Pa, and at a base film temperature of not more than 70° C. under a bias potential of not more than −100 V applied to the base film.

In other words, on the CVD apparatus 10 as shown, silane gas, ammonia gas, as well as hydrogen gas and/or nitrogen gas are fed from the gas feeding means 46 so that the ratio P/Q between the electric power P supplied from the radio-frequency power source 48 to the showerhead electrode 38 and the flow rate Q of the silane gas fed from the gas feeding means 46 may be lower than 10 W/sccm and the deposition pressure may be 20 to 200 Pa, the temperature of the base film Z is kept at 70° C. or lower by the temperature adjusting means built in the drum 36, and a bias potential of not more than −100 V is applied to the drum 36 by the bias power source 44, so as to deposit a silicon nitride layer on the surface of the base film Z by CCP-CVD.

According to the study done by the inventor of the present invention, if the major electric power P supplied for plasma generation in CCP-CVD, namely, the electric power P supplied to the showerhead electrode 38 in the case of the CVD apparatus 10 as shown in FIG. 1 is increased relative to the sialne gas flow rate Q, a silicon nitride layer deposited on a base film becomes denser, with its gas barrier property being improved. A denser silicon nitride layer, however, is less flexible and is reduced more in resistance to flexing. Such a layer may be broken and reduced in gas barrier property if bent, for instance.

After a diligent study in order to solve the above problem, the inventor of the present invention has found that making the ratio P/Q between the major electric power P supplied for plasma generation and the silane gas flow rate Q lower than 10 W/sccm allows a silicon nitride layer deposited on a base film to be flexible and excellent in resistance to flexing, that is to say, allows a silicon nitride layer of high flexibility.

Another problem with the deposition of a layer by CCP-CVD is particles liable to occur. Particles getting into a silicon nitride layer may reduce the layer in gas barrier property considerably, which makes it impossible to obtain a gas barrier film with an expected performance.

Generally speaking, particles formed during the deposition using the gaseous raw material as above under such deposition conditions as described above are negatively charged. In the present invention that takes advantage of this fact, a silicon nitride layer is deposited while a bias potential of not more than −100 V is applied to the base film Z. As a result, particles are brought into such a state that they could be floating with respect to the base film Z, and thus prevented from getting into a silicon nitride layer in the process of deposition.

In other words, the present invention, as depositing a silicon nitride layer on the base film Z under the conditions as described above, makes it possible to use a base film of low resistance to heat, such as a PET film, as the base film Z so as to stably manufacture a gas barrier film of high quality exhibiting a high flexibility and an excellent gas barrier property, with the reduction of a silicon nitride layer in gas barrier property due to particles getting into the layer being suppressed, on an inexpensive apparatus with a good production efficiency.

In the present invention, the ratio P/Q [W/sccm] between the major electric power P [W] supplied to an electrode for plasma generation and the silane gas flow rate Q [sccm] is less than 10 W/sccm.

If the ratio P/Q is 10 W/sccm or more, a silicon nitride layer deposited on a base film will be too dense and, accordingly, be inadequately flexible and less resistant to flexing, which may cause the layer to be broken and reduced in gas barrier property if bent, for instance. In the case where a layer is to be deposited by a roll-to-roll method, it is often necessary to bend a base film with a guide roller or the like in order to transport it in a different direction. Moreover, the base film with a layer deposited thereon is rolled up by a roll up shaft. The layer as deposited may be broken and reduced in gas barrier property due to the bending upon transportation or rolling up of the base film if the layer is inadequately flexible and less resistant to flexing.

While the ratio P/Q is not particularly defined in lower limit, a ratio P/Q of not less than 1 W/sccm is preferable because a more suitable gas barrier property is achieved.

It should be noted that neither the silane gas nor the ammonia gas is particularly limited in flow rate, and the flow rates of the gases may be specified appropriately to the fulfillment of the above conditions in accordance with required deposition rate, area of a layer deposited, and so forth.

The hydrogen gas and the nitrogen gas each serve chiefly as a dilution gas. Either one or both of the hydrogen and nitrogen gases may be used.

The use of hydrogen gas is advantageous in that inclusion of hydrogen in a silicon nitride layer is suppressed. Use of nitrogen gas is advantageous in that the gas also serves as a source of nitrogen for a silicon nitride layer so as to improve the deposition rate.

Neither of the hydrogen and nitrogen gases is particularly limited in flow rate, and the flow rates of the gases may be specified appropriately in accordance with required deposition rate and so forth. It is preferable that the flow rate of not only the hydrogen gas but the nitrogen gas is 5 to 10 times as high as the flow rate of the silane gas. If the hydrogen gas and the nitrogen gas are used in combination, their flow rates in total are preferably 5 to 10 times as high as the flow rate of the silane gas.

The major electric power P for plasma generation, namely, the electric power P supplied to the showerhead electrode 38 in the shown example is not particularly limited in strength, and its strength may be specified appropriately in accordance with required deposition rate and so forth. In other words, the electric power P may be so specified in accordance with the silane gas flow rate as to fall within the scope of the invention.

The electric power P is not particularly limited in frequency either. Various types of electric power at different frequencies used for the deposition of a silicon nitride layer by CCP-CVD are available.

In the present invention, the deposition pressure is 20 to 200 Pa.

A deposition pressure of more than 200 Pa may cause large particles to be generated in a huge amount by a vapor phase reaction during deposition, and such particles are hardly prevented from getting into a layer by the application of a bias potential to the base film Z, leading to the reduction of the layer in gas barrier property and other properties due to the particles getting into the layer.

A deposition pressure of less than 20 Pa raises the apparatus costs because it requires a means of vacuum evacuation or vacuum chamber of high performance to be provided. The apparatus costs will be raised vastly with a deposition pressure of less than 20 Pa especially if the deposition rate is to be improved so as to manufacture a gas barrier film with a high productivity. In other words, according to the present invention, a gas barrier film of high quality exhibiting a good gas barrier property over a long period of time can be manufactured on an inexpensive apparatus with a high productivity.

A deposition pressure of 40 to 100 Pa is more preferred because it allows a more suitable suppression of the particles' presence in a silicon nitride layer, and allows suitably a further decrease in apparatus costs.

In the manufacturing method of the present invention, the temperature of the base film Z is kept at 70° C. or lower during the deposition of a silicon nitride layer.

If the temperature of the base film Z is to be made higher than 70° C., a gas barrier film cannot be manufactured using a base film of low resistance to heat, such as a PET film, as the base film Z.

The base film temperature is not particularly defined in lower limit, so that any temperature not higher than 70° C. will do as long as it allows a silicon nitride layer to be deposited in accordance with the deposition conditions and so forth.

Also in the manufacturing method of the present invention, a bias potential of not more than −100 V is applied to the base film Z during deposition. In other words, on the CVD apparatus 10 as shown, a silicon nitride layer is deposited on the base film Z while electric power (bias power) supplied from the bias power source 44 to the drum 36 is adjusted in accordance with the deposition pressure and so forth so that the drum 36 also serving as an electrode may be at a potential of not more than −100V.

The bias potential to be applied to the base film Z may be the radio-frequency potential whose direct-current component (Vdc) is −100 V or lower, or the DC pulse potential in which the minimum potential is −100 V or lower.

In the deposition of a layer by CCP-CVD, the purpose for applying a bias potential to a base film during deposition is generally to make a layer denser, for instance. According to the present invention, in contrast, a bias potential is applied to the base film Z during deposition in order to achieve an effect quite different from conventional ones, that is to say, in order to prevent particles from getting into a layer.

As described before, particles generated by a vapor-phase reaction under the deposition conditions of the present invention are negatively charged. Accordingly, by applying a bias potential of not more than −100 V to the base film Z, the particles which are about to intrude into the base film Z (or, a silicon nitride layer in the process of being deposited thereon) are brought into such a state that they are floating with respect to the base film Z, and thus prevented from getting into a silicon nitride layer in the process of deposition. In consequence, the present invention significantly relieves the reduction of a silicon nitride layer in gas barrier property due to particles getting into the layer.

If a bias potential applied to the base film Z exceeds −100 V, the effect of preventing particles from getting into a silicon nitride layer will be inadequate and the gas barrier property of a gas barrier film will be reduced, so that it is impossible to stably manufacture a gas barrier film having an expected gas barrier property.

On the other hand, the bias potential to be applied to the base film Z is not particularly defined in lower limit, and its lower limit may be specified appropriately in accordance with the major electric power supplied for plasma generation (electric power supplied to the showerhead electrode 38 in the shown example) and so forth, with a potential of −700 V being preferred as the lower limit.

The bias potential to be applied to the base film Z whose lower limit is −700 V brings about more desirable results, that is to say, it ensures that the reduction in gas barrier property due to the ion bombardment of the base film Z caused by a bias potential with excessive effects (too large a bias potential in magnitude) is prevented, and so forth.

While not particularly limited, the frequency of the bias potential to be applied to the base film Z, namely, the radio-frequency potential (power) to be supplied to the drum 36 is preferably as high as 100 kHz or more. If a pulse potential is to be applied to the base film Z as a bias potential, it is preferable to apply a pulse potential at a frequency of not less than 100 kHz.

With such a configuration as above, the period of time for which an effective bias potential is not applied to the base film Z is reduced to achieve more suitably the effect of preventing particles from getting into a silicon nitride layer.

It is more preferable that the frequency of the bias potential to be applied to the base film Z is 400 kHz or higher because such an effect as above is achieved even more suitably.

The electric power for the application of a bias potential to the base film Z (namely, electric power supplied from the bias power source 44) is not particularly limited, but may be specified appropriately in accordance with the major electric power for plasma generation and so forth.

The base film Z on which a functional layer (a silicon nitride layer) has been deposited (namely, the functional film (the gas barrier film) thus obtained) is transported from the drum 36 to the guide roller 42, then, as being guided by the guide roller 42, further transported to the roll up chamber 16 through a slit 56a formed in a partition 56 separating the deposition chamber 14 and the roll up chamber 16 from each other.

In the shown example, the roll up chamber 16 is provided with a guide roller 58, the roll up shaft 30, and the means of vacuum evacuation 60.

The base film Z (functional film) as transported to the roll up chamber 16 is guided by the guide roller 58 to the roll up shaft 30, and rolled up by the roll up shaft 30 into a functional film roll so as to subject it as such to a next operation.

As is the case with the feeding chamber 12, the roll up chamber 16 provided with the means of vacuum evacuation 60 is reduced in the pressure therein during deposition to a degree of vacuum corresponding to the deposition pressure in the deposition chamber 14.

The CVD apparatus 10 as shown in FIG. 1 is a roll-to-roll apparatus on which a layer is deposited on the continuous base film which is wound onto a drum while transported in its longitudinal direction. The gas barrier film manufacturing method of the present invention, however, is not limited to the shown apparatus, but is suitably applicable also to a roll-to-roll apparatus for deposition by CCP-CVD provided with a pair of plate electrodes positioned opposite to each other in a deposition chamber, on which apparatus a continuous base film is transported in its longitudinal direction between the electrodes, and gaseous raw material are fed between the base film and the electrodes. In addition, the inventive method is suitably applicable to a so-called batch-type apparatus for manufacturing a gas barrier film by depositing a silicon nitride layer on a base film in cut-sheet form.

As described before, it is often necessary on a roll-to-roll apparatus to bend a base film being transported with a guide roller or the like so as to transport it in a different direction. Moreover, the base film on which a layer has been deposited is successively discharged from a deposition chamber (namely, the space in which deposition of a layer is performed), and rolled up by a roll up shaft. Thus, on a roll-to-roll apparatus, the base film with a layer deposited thereon may frequently be bent during transportation or rolling up, and the layer as deposited may be broken and reduced in gas barrier property due to the bending if the layer is less resistant to flexing. Consequently, the present invention capable of depositing a layer having a high flexibility is suitably applicable to roll-to-roll apparatus.

The present invention is suitably applicable in particular to the case where a base film is transported along a path having a section in which the base film is bent at a radius of curvature of not more than 50 mm.

On a batch-type apparatus, the base film on which a layer has been deposited must be removed from a vacuum chamber after the bias potential as applied to the base film is shut off.

Since the effect of preventing particles from intruding into the base film is no more exerted at the time when the bias potential as applied to the base film is shut off, particles are then adhered to the surface of the silicon nitride layer, and the surface of the base film is soiled. If a layer is to be deposited on a surface directed upward in particular, the particles which have been caused by a bias potential to float above the base film fall onto the base film at a time, leading to the soilage of the base film surface.

In contrast, on a roll-to-roll apparatus, the base film on which a layer has been deposited is successively discharged from a deposition chamber (namely, the space in which deposition of a layer is performed), and rolled up.

Accordingly, particles are prevented from being adhered to the surface of the silicon nitride layer even if the bias potential as applied to the base film is shut off in the deposition chamber at the end of deposition (at the end of the manufacture of a gas barrier film). Particles may perhaps be adhered but to an extremely limited part, such as a terminal portion, of a continuous base film.

The gas barrier film manufacturing method according to the present invention has thus been described in detail, while the present invention is in no way limited to the above. As a matter of course, various improvements or modifications can be made without departing from the gist of the invention.

### EXAMPLES

Specific examples of the present invention are presented below to describe the present invention in more detail.

### Example 1

Using the CVD apparatus 10 as shown in FIG. 1, a 100 nm-thick silicon nitride layer was deposited on the surface of the base film Z to manufacture a gas barrier film.

A PET film with a thickness of 100 μm (COSMOSHINE A4300, manufactured by Toyobo Co., Ltd.) was used as the base film Z. The portion of the film on which the layer is to be deposited had a length of 1000 m.

The gaseous raw materials as used were silane gas (SiH₄; the flow rate, 50 seem), ammonia gas (NH₃; the flow rate, 50 sccm), and nitrogen gas (N₂; the flow rate, 400 sccm).

The drum as used was made of SUS 304 stainless steel as a base material with hard chrome plating, measured 1000 mm in diameter, and had a temperature adjusting means built therein.

The pressure in the deposition chamber (vacuum chamber) was 40 Pa.

During deposition, the base film temperature was kept at 70° C. by the temperature adjusting means built in the drum.

The functional layer as deposited had a thickness of 100 nm.

The bias power source connected to the drum was an electric power source operating at a frequency of 100 kHz, whose output was modified so that the potential of the drum might be −100 V.

The radio-frequency power source connected to the showerhead electrode was a radio-frequency power source operating at a frequency of 13.56 MHz, which supplied 300 W of electric power to the showerhead electrode.

In this Example, accordingly, the ratio of the electric power supplied to the showerhead electrode 38 to the silane gas flow rate, P/Q, was 300 W/50 sccm, or 6 W/sccm.

### Examples 2 Through 5

A silicon nitride layer was deposited on the surface of the base film Z to manufacture a gas barrier film by following the procedure in Example 1 except that:

475 W of electric power was supplied from the radio-frequency power source to the showerhead electrode, so that the ratio P/Q was 9.5 W/sccm (Example 2); or

the deposition pressure was 200 Pa (Example 3); or

the deposition pressure was 20 Pa (Example 4); or the frequency of the bias potential applied by the bias power source to the drum, that is to say, the frequency of the bias potential applied to the base film Z was 50 kHz (Example 5).

### Comparative Examples 1 Through 4

A silicon nitride layer was deposited on the surface of the base film Z to manufacture a gas barrier film by following the procedure in Example 1 except that:

550 W of electric power was supplied from the radio-frequency power source to the showerhead electrode, so that the ratio P/Q was 11 W/sccm (Comparative Example 1); or

the base film temperature was 100° C. (Comparative Example 2); or

the bias potential applied by the bias power source to the drum was −80 V (Comparative Example 3); or

the deposition pressure was 210 Pa (Comparative Example 4).

Each of the gas barrier films thus obtained was examined in gas barrier property and resistance to flexing, and the results were evaluated comprehensively.

### <Gas Barrier Property>

The water vapor transmission rate (WVTR) [g/m²/day] was measured using a water vapor transmission rate measuring instrument “AQUATRAN” manufactured by MOCON, Inc.

### <Resistance to Flexing>

A sample of each gas barrier film was measured for water vapor transmission rate, then wound one turn onto a cylindrical rod 10 mm in diameter, and finally measured again for water vapor transmission rate. If the water vapor transmission rate of the relevant film after the winding onto the cylindrical rod did not differ from that before the winding, the film was considered to have a good resistance to flexing, which is denoted in Table 1 by “O” mark. If the water vapor transmission rate was increased, or deteriorated, after the winding as compared with that before the winding, the film was considered to have a poor resistance to flexing, which is denoted in Table 1 by “X” mark.

### <Comprehensive Evaluation>

Those films having a gas barrier property of not more than 0.005 g/m²/day and a good resistance to flexing were evaluated as excellent.

Those films having a gas barrier property of more than 0.005 g/m²/day but less than 0.02 g/m²/day and a good resistance flexing were evaluated as good.

Those films having either one or both of a gas barrier property of not less than 0.02 g/m²/day and a poor resistance to flexing were evaluated as useless.

Deposition conditions and evaluation results are set forth in Table 1.

TABLE 1

| | Deposition condition | | | | | | Evaluation result | | |
|---|---|---|---|---|---|---|---|---|---|
| | | | | Base film | Deposition | | | Resistance | Comprehensive |
| | RF power | Bias | P/Q | temperature | pressure | Bias frequency | WVTR | to flexing | evaluation |
| Ex. 1 | 300 | −100 | 6 | 70 | 40 | 100 | 0.002 | ◯ | excellent |
| Ex. 2 | 475 | −100 | 9.5 | 70 | 40 | 100 | 0.006 | ◯ | good |
| Ex. 3 | 300 | −100 | 6 | 70 | 200 | 100 | 0.008 | ◯ | good |
| Ex. 4 | 300 | −100 | 6 | 70 | 20 | 100 | 0.002 | ◯ | excellent |
| Ex. 5 | 300 | −100 | 6 | 70 | 20 | 50 | 0.012 | ◯ | good |
| Comp. | 550 | −100 | 11 | 70 | 40 | 100 | 0.004 | X | useless |
| Ex. 1 | | | | | | | | | |
| Comp. | 300 | −100 | 6 | 100 | 40 | 100 | unmeasurable | unmeasurable | useless |
| Ex. 2 | | | | | | | | | |
| Comp. | 300 | −80 | 6 | 70 | 40 | 100 | 0.12 | ◯ | useless |
| Ex. 3 | | | | | | | | | |
| Comp. | 300 | −100 | 6 | 70 | 210 | 100 | 0.15 | ◯ | useless |
| Ex. 4 | | | | | | | | | |

As seen from Table 1 above, the gas barrier films manufactured by the manufacturing method of the present invention were superior in gas barrier property (WVTR) and resistance to flexing, that is to say, were gas barrier films of high quality. The film of Example 5 that was manufactured with a bias potential at a frequency of 50 kHz being applied to the base film Z is considered to have had more particles getting into its silicon nitride layer than the film of any other Example, and was somewhat low in gas barrier property in comparison with other Examples, although it will mostly be usable with no practical problems.

In contrast, the gas barrier film of Comparative Example 1 that was manufactured with too large a ratio P/Q, that is to say, with too high an electric power for plasma generation being supplied had its water vapor transmission rate deteriorated after the winding onto the cylindrical rod in spite of a favorable water vapor transmission rate before the winding. It appears because the silicon nitride layer as deposited was too dense and, consequently, was brittle with a poor resistance to flexing.

The gas barrier film of Comparative Example 2 that was manufactured with too high a base film temperature could be measured neither for gas barrier property nor resistance to flexing because its base film was deformed by heat, so that it was impossible to form a normal layer.

The gas barrier film of Comparative Example 3 that was manufactured with too high a bias potential (too small a bias potential in magnitude) being applied to the base film was reduced in gas barrier property because the particles' presence in the silicon nitride layer was not suppressed adequately.

In addition, the gas barrier film of Comparative Example 4 that was manufactured with too high a deposition pressure was reduced in gas barrier property because large particles were generated a huge amount, so that the particles' presence in the silicon nitride layer was suppressed adequately even though the bias potential was applied to the base film Z.

The evaluation results as described above clearly demonstrate the effectiveness of the present invention.

What is claimed is:

1. A method of manufacturing a gas barrier film, comprising:
using silane gas, ammonia gas, and either one or both of nitrogen gas and hydrogen gas as gaseous raw materials; and
depositing a silicon nitride layer on a surface of a base film by capacitively-coupled plasma CVD at a ratio P/Q [W/sccm] of less than 10 W/sccm, with Q [sccm] being a flow rate of the silane gas and P [W] being electric power supplied for plasma generation, a deposition pressure of 20 to 200 Pa, and at a base film temperature of not more than 70° C. while applying a bias potential of not more than −100 V to the base film.

2. The method of manufacturing a gas barrier film according to claim 1, wherein said bias potential applied to the base film has a frequency of not less than 100 kHz.

3. The method of manufacturing a gas barrier film according to claim 2, wherein said bias potential applied to the base film has a frequency of not less than 400 kHz.

4. The method of manufacturing a gas barrier film according to claim 1, wherein said base film is a continuous base film rolled up into a base film roll, which is delivered from the base film roll, transported in its longitudinal direction, and subjected to deposition of said silicon nitride layer during transportation, and the base film with said silicon nitride layer deposited thereon is rolled up.

5. The method of manufacturing a gas barrier film according to claim 4, wherein said base film is transported along a path having a section in which said base film is bent at a radius of curvature of not more than 50 mm.

6. The method of manufacturing a gas barrier film according to claim 4, wherein said base film is wound onto a cylindrical drum in a specified area of a peripheral surface thereof during transportation, and the drum is used as an electrode for deposition.

7. The method of manufacturing a gas barrier film according to claim 6, wherein a temperature adjusting means is used to adjust said drum in temperature.

8. The method of manufacturing a gas barrier film according to claim 1, wherein said flow rate Q [sccm] of the silane gas and said electric power P [W] supplied for plasma generation satisfy an expression 1≦P/Q<10 [W/sccm].

9. The method of manufacturing a gas barrier film according to claim 1, wherein a material for said base film is a resin having a glass transition temperature of not more than 70° C.

10. The method of manufacturing a gas barrier film according to claim 1, wherein said bias potential applied to the base film is not less than −700 V and at the same time not more than −100 V.

11. The method of manufacturing a gas barrier film according to claim 1, wherein a deposition pressure is 40 to 100 Pa.
